(19) United States
(12) Patent Application Publication
(10) Pub. No.: US 2024/0202650 A1
(43) Pub. Date: Jun. 20, 2024

(54) MOBILITY APPARATUS AND A METHOD OF CONTROLLING THE SAME

(71) Applicants: Hyundai Motor Company, Seoul (KR); Kia Corporation, Seoul (KR)

(72) Inventors: HeeJin RO, Seoul (KR); Donghee SEOK, Seoul (KR)

(21) Appl. No.: 18/452,975

(22) Filed: Aug. 21, 2023

(30) Foreign Application Priority Data
Dec. 16, 2022 (KR) 10-2022-0177422

(51) Int. Cl. G06Q 10/0833; G06V 20/64

(52) U.S. Cl. CPC G06Q 10/0833; G06V 20/64

(57) ABSTRACT

A mobility apparatus includes a base part including a loading part and having a device for driving, and a cargo part detachably coupled to the loading part and having a space to store one or more products for delivery, wherein the cargo part includes an product identifier configured to recognize the one or more products when the one or more products are received and released.

### CROSS-REFERENCE TO RELATED APPLICATION(S)

This application claims the benefit of Korean Patent Application No. 10-2022-0177422, filed on Dec. 16, 2022, which application is hereby incorporated by reference in its entirety.

### TECHNICAL FIELD

The present disclosure relates to a mobility apparatus and a method of controlling the same, and more particularly, to a mobility apparatus with a cargo part to transport and deliver objects and a method of controlling the same.

### BACKGROUND

A multitude of mobility devices are employed for the transportation of goods, each compassing distinct types. For example, a box truck encloses a cargo section to securely store the goods. To ensure the preservation of freshness, this cargo section can include refrigeration or freezing equipment, enabling the delivery of perishable food items. In addition, these vehicle may incorporate protective structures to safeguard the stored goods from potential damage caused by external impacts.

Such mobility devices for product delivery are generally tailored to serve specific functions, often limited to one or two purposes. For example, box trucks and similar vehicles are remanufactured or produced specifically for certain applications. Thus, utilizing these vehicles for purposes other than those for which they were initially manufactured can pose challenges due to their specialized nature.

Furthermore, the rise of expansive logistics companies enables the consolidation management, and simultaneous delivery of various items within a centralized distribution center. Consequently, if a mobility device is manufactured for a specific function, such as product delivery, its versatility becomes diminished in such contexts.

### SUMMARY

The present disclosure is directed to a mobility apparatus configured to deliver objects in various ways and a method of controlling the same.

According to one aspect of the subject matter described in this application, a mobility apparatus includes a base part including a loading part and having a device for driving, and a cargo part detachably coupled to the loading part and having a space to store one or more products for delivery, wherein the cargo part includes an product identifier configured to recognize the one or more products when the one or more products are received and released.

The base part may include an input/output device configured to display a delivery destination where the one or more products are delivered and a delivery route, and be input information from a user, and a first controller configured to recognize that the cargo part is coupled to the loading part, and control the input/output device.

The cargo part may further include a second controller configured to communicate with the first controller to transmit information about the one or more products to the first controller.

The first controller may receive information recognized by the product identifier through the second controller when the one or more products are received, and control the input/output device so that the input/output device displays the delivery destination and the delivery route to which the one or more products are to be delivered according to the recognized information.

The first controller may transmit the recognized information to a server externally located, and receive information about the delivery destination and the delivery route for the one or more products from the server.

The cargo part may further include a terminal communicator configured to communicate with a user terminal used by a user, and the terminal communicator is configured to receive an image to prove delivery completion of the one or more products from the user terminal.

The second controller may receive the image from the terminal communicator and match the image with a delivery completed product.

The first controller may receive the image from the second controller and transmit the received image to an external server to be transmitted to a customer of the delivery completed product.

The second controller may store information recognized by the product identifier when the one or more products are received in the cargo part.

The second controller may transmit information about the one or more stored products when the cargo part is coupled to the loading part to the first controller.

According to another aspect of the subject matter described in this application, a method of controlling a mobility apparatus includes receiving one or more products for delivery to a cargo part, coupling the cargo part to a loading part of a base part, the base part including a device for driving, transmitting information about the one or more products to the base part when the cargo part is coupled to the loading part, and delivering the one or more products by driving the base part,

The cargo part may include a second controller in which information about the one or more products is stored, and the base part includes a first controller in which information about the one or more products is received from the second controller, the transmitting of the information about the one or more products may include communication connection between the first controller and the second controller to transmit the information.

The base part may further include an input/output device configured to display a delivery destination where the one or more products are delivered and a delivery route, and is controlled by the first controller, and the delivering of the one or more products may include displaying the delivery destination and the delivery route on the input/output device.

The storing of the one or more products may include inputting information about the one or more products through a product identifier disposed in the cargo part.

The delivering of the one or more products may further include inputting information in which the one or more products are released through the product identifier, and confirming whether the one or more products and the delivery destination are matched when the one or more products are released.

The confirming whether the one or more products and the delivery destination are matched may include confirming whether the delivery destination of the product recognized by the product identifier and a location of the base part are within a predetermined range in the first controller.

The method may further include recognizing an image in order to prove that the one or more products has been delivered, and transmitting the image to the outside so that the image is transmitted from the first controller to a customer of the delivered one or more products.

The method may further include matching the image and the delivered products in the second controller.

The first controller may transmit the image to an external server so that the image is transmitted to the customer.

### BRIEF DESCRIPTION OF THE DRAWINGS

FIG. 1 is a diagram illustrating an example of a mobility device;

FIG. 2 is a block diagram illustrating an example of a mobility device.

FIG. 3 is a diagram illustrating an example of a structure of software installed in a first controller of a mobility device.

FIG. 4 is a diagram illustrating an example of a structure of software installed in a second controller of a mobility device.

FIG. 5 is a diagram showing a first part of a flowchart for explaining an example of a method of controlling a mobility device.

FIG. 6 is a diagram showing a second part of the flowchart for explaining the example of the method of controlling a mobility device.

### DETAILED DESCRIPTION

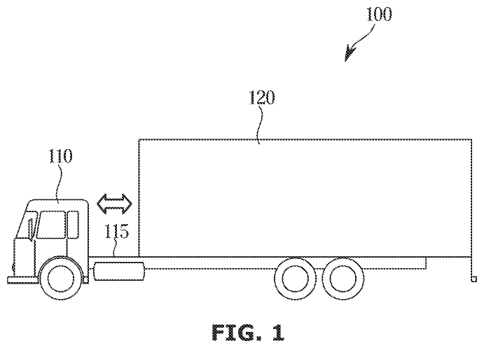

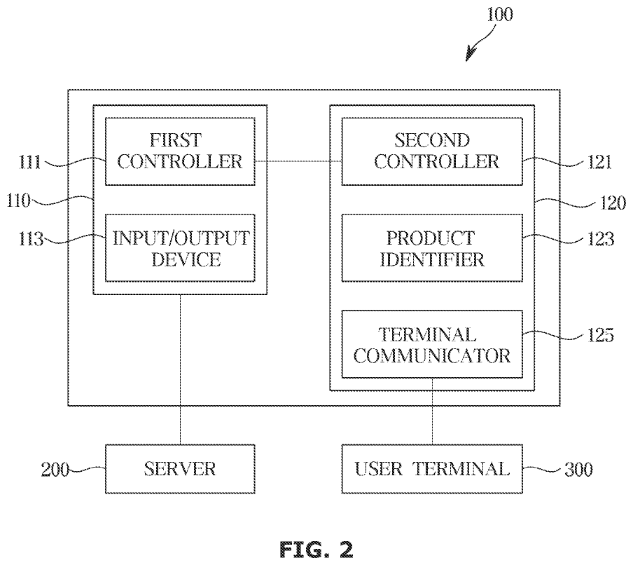

Referring to FIG. 1 to FIG. 4, a mobility device 100. The mobility device 100 may deliver goods, and will be described using a truck for delivering goods as an example. The mobility device 100 includes a base part 110 and a cargo part 120.

In the base part 110, a driver's seat for controlling the mobility device 100 is disposed, and a loading part 115 in which the cargo part 120 may be loaded is disposed behind the driver's seat. On a position where the driver's seat is disposed is provided with a space for the driver to get on, and various devices capable of driving the mobility device 100 may be disposed. In addition, an input/output device 113 may be installed in a space where the driver's seat is provided, and a first controller 111 for various controls may be installed therein.

The first controller 111 may determine what kind of cargo is stored in the cargo part 120 when the cargo part 120 is mounted on the loading part 115 of the base part 110. As the first controller 111 is included in the base part 110, a second controller 121 is included in the cargo part 120 to be described later. Accordingly, the first controller 111 may identify the type of cargo part 120 via a communication with the second controller 121.

For example, when the cargo part 120 is mounted on the loading part 115 of the base part 110, the base part 110 and the cargo part 120 are electrically connected to each other, and thus the first controller 111 enables a communication with and the second controller 121. Alternatively, if necessary, the first controller 111 may recognize that the cargo part 120 is mounted on the loading part 115 through a pressure sensor or a proximity sensor, and accordingly may communicate with the second controller 121 via a wireless communication.

Herein, the first controller 111 may be a plug and play (P&P) controller installed in the base part 110, and the second controller 121 may be a P&P controller installed in the cargo part 120.

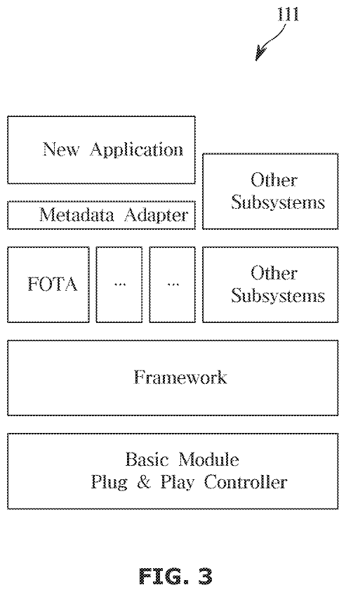

To this end, the first controller 111 may have a software structure as shown in FIG. 3. A basic module of the first controller 111 may be communicatively connected to a central controller (e.g., central communication unit (CCU)) and other controllers (e.g., battery management system (BMS), parking distance control (PDC), or the like) of the vehicle. In addition, a framework of the first controller 111 may include a meta adapter suitable for characteristics of the mobility device 100.

The first controller 111 serves as a main communication means (e.g., a controller area network (CAN) communication, Ethernet, etc.) in the base part 110, and includes an external interface to process various data.

In addition, the first controller 111 may perform encryption and data transmission/reception, which are basic structures for connecting and controlling additional modules at a framework level. For example, the first controller 111 may allocate five CAN communication IDs in advance (e.g., 111, 222, 333, 444, and 555) and allocate maximum period information (e.g., 10 ms, 50 ms, 100 ms, 250 ms, and 1000 ms) and adjust by forming a part or connect to Ethernet.

In addition, the first controller 111 may communicate with a server 200 provided outside the mobility device 100, and may transmit/receive various information for delivering goods from the server 200. For example, the first controller 111 may transmit and receive information about an item and a delivery route for delivering the items from the server 200. Herein, the first controller 111 may receive information about the type, quantity, delivery address, and the like of goods stored in the cargo part 120 from the second controller 121, transmit the information about the goods to the server 200, and receive delivery route information for delivering goods from the server 200.

In addition, upon receipt of delivery route information about goods from the server 200, the first controller 111 may control the input/output device 113 so that the delivery route information is displayed on the input/output device 113.

The input/output device 113 may be disposed in a space where a driver's seat is provided, and various types of information may be displayed thereon. The input/output device 113 installed in the vehicle allows the driver to input information for controlling various devices of the vehicle. The input/output device 113 may be, for example, in-vehicle infotainment (IVI), and may provide information on driving, such as a status of the mobility device 100 and a route guidance, and entertainment elements for occupants of the mobility device 100 together.

For example, the input/output device 113 may perform various functions, such as providing road information through a vehicle navigation and providing restaurant reservations while providing information on restaurants in a vicinity of the driving area.

The loading part 115 is disposed rearward from the position where the driver's seat is disposed to have a predetermined length and width, and also may be disposed at a position relatively lower than the driver's seat. In the loading part 115, the cargo part 120 having a certain size may be disposed and loaded thereon. In some implementations, the loading part 115 may have a standardized size, and may include a coupling device for engaging the cargo part 120 when the cargo part 120 is loaded on the loading part 115.

The cargo part 120 may be loaded and disposed on the loading part 115 of the base part 110, and as shown in FIG. 1, may have a certain. The cargo part 120 may have a roughly rectangular parallelepiped shape and have a predetermined space to store items therein. In addition, a door may be installed on one side of the cargo part 120 to open and close the interior space thereof. The cargo part 120 includes the second controller 121, a product identifier 123, and a communicator.

The second controller 121 may communicate with the first controller 111 and transmit information about the cargo part 120 and information about products stored in the cargo part 120 to the first controller 111. Information on the cargo part 120 may be information such as whether the cargo part 120 enables refrigerating or freezing products or has a structure capable of preventing stored products from being damaged by external impact. Information about the products stored in the cargo part 120 may include information about the type, quantity, and delivery destination of the products. When a communication connection with the first controller 111 is established, the second controller 121 may immediately transmit information about the cargo part 120 and information about products stored in the cargo part 120 to the first controller 111.

Herein, the second controller 121 may store information about the cargo part 120 when the cargo part 120 is manufactured, and also receive information about products stored in the cargo part 120 through the product identifier 123.

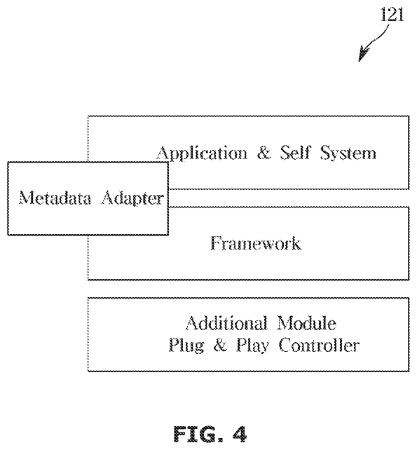

Furthermore, the second controller 121 may have a software structure as shown in FIG. 4, and various communication methods may be applied to internal communication thereof. In addition, the second controller 121 may communicate with a metadata adapter of the first controller 111 through a metadata adapter of the second controller 121 for communication with the first controller 111. At this time, CAN communication method or Ethernet communication method may be used for communication with each other.

In some implementations, the first controller 111 and the second controller 121 may be implemented by a computing device including a microprocessor, memory, or the like, and an implementation method thereof is obvious to those skilled in the art, so no further detailed description will be given.

The product identifier 123 is disposed inside the cargo part 120, recognizes products when the products enter the cargo part 120, and also recognizes the products when the products leave the cargo part 120. The product identifier 123 may be, for example, a scanner for recognizing a barcode or quick response (QR) code, and may be operated by a user who delivers goods when a product is received or exited from the cargo part 120.

The product identifier 123 transmits information acquired while goods are received and exited to the second controller 121.

The product identifier 123 may be mounted on an inner wall of the cargo part 120, and a barcode or QR code on the product may be recognized in a process of the user placing the product into or out of the cargo part 120. Although the product identifier 123 is described as being mounted on the inner wall of the cargo part 120, it is not limited thereto, and the product identifier 123 may be a handheld type that can be carried by a user to recognize a barcode or QR code written on a product. Alternatively, the product identifier 123 may utilize radio frequency identification (RFID) or a vision camera for photographing the product.

A terminal communicator 125 may communicate with a user terminal 300 possessed by a user and receive an image or information captured by the user terminal 300. For example, the terminal communicator 125 may receive an image photographed by the user terminal 300 to prove delivery completion, and transmit the received image to the second controller 121.

Accordingly, when an image that may prove delivery completion is received through the terminal communicator 125, the terminal communicator 125 may transmit the corresponding image to the second controller 121 and the second controller 121 may transmit the corresponding image to the first controller 111 again. In addition, the server 200 may receive the image proving delivery completion from the first controller 111 and transmit a guide and a picture for delivery completion to a terminal owned by the user.

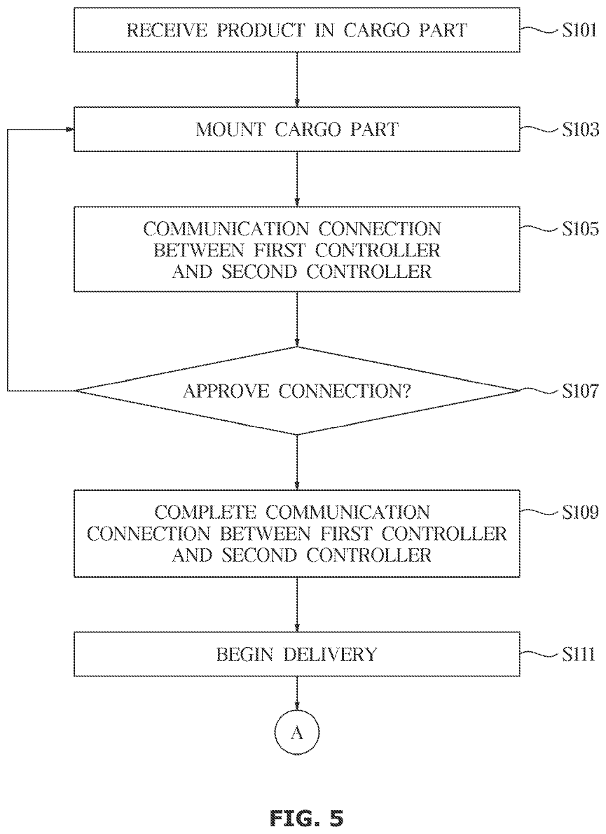

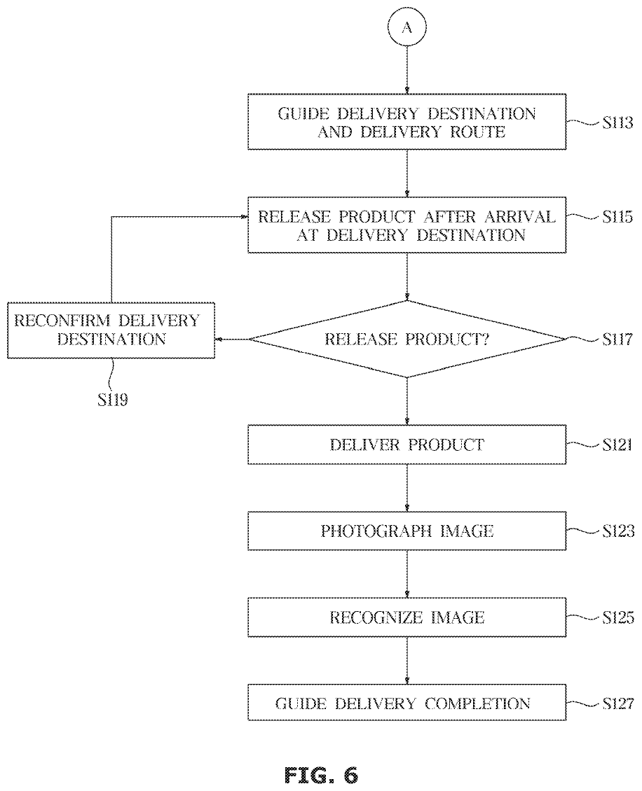

Referring to FIG. 5 and FIG. 6, a method for controlling the mobility device 100 will be described. While describing the method for controlling the mobility device 100, it will also be described with reference to FIG. 1 to FIG. 4.

The one or more products are received in the cargo part 120 (S101).

The one or more products are received in the cargo part 120, and the one or more products to be stored may be recognized through the product identifier 123 while the products are received. When the products are received in the cargo part 120, the cargo part 120 may be in a state in which the cargo part 120 is not coupled to the base part 110. In other words, while the cargo part 120 is separated from the base part, the products may be received therein. In addition, in a process of the products being received, information about products stored in the cargo part 120 may be recognized through the product identifier 123.

Herein, information about the product may include information on the type of products to be received and the delivery destination of the products. The information about the product recognized through the product identifier 123 may be transmitted to the second controller 121, and the second controller 121 may store the information transmitted from the product identifier 123.

The cargo part 120 is mounted on the base part 110 (S103).

When the one or more products has been received, the cargo part 120 closes the opened door thereof and then mounted on the base part 110. The cargo part 120 may be mounted on the base part 110 by using a crane or the like, and may be coupled to the base part 110 after mounting thereon. Herein, coupling the cargo part 120 to the base part 110 may be manually made by a user, or may be automatically made as needed.

Communication between the first controller 111 and the second controller 121 is connected (S105).

After the cargo part 120 is coupled to the base part 110, a request for the communication connection between the first controller 111 and the second controller 121 may be made. The communication between the first controller 111 and the second controller 121 may be made by connecting a separate communication cable after the cargo part 120 is mounted on the base part 110, but is not limited thereto. Alternatively, the communication may be connected not through wired communication but wireless communication.

Whether the connection between the first controller 111 and the second controller 121 is approved is confirmed (S107).

In S105, the communication connection between the first controller 111 and the second controller 121 is established in such a way that the second controller 121 requests the first controller 111 to establish a communication connection. As a result, in S105, the communication connection between the first controller 111 and the second controller 121 may be completed when the first controller 111 approves the request for the communication connection of the second controller 121.

More specifically, the approval for the second controller 121 to be in communication with the first controller 111 after the cargo part 120 is mounted on the base part 110 may be requested to the user through the input/output device 113. Then, when information allowing the user to approve the communication connection between the first controller 111 and the second controller 121 is input through the input/output device 113, the communication connection between the first controller 111 and the second controller 121 may be approved.

If the communication connection between the first controller 111 and the second controller 121 is not approved (NO in S107), returning to S103.

The communication connection between the first controller 111 and the second controller 121 is completed (S109).

If the communication connection between the first controller 111 and the second controller 121 is approved by the user (YES in S107), the communication between the first controller 111 and the second controller 121 is completed. Accordingly, information on the cargo part 120 and information on products may be transmitted from the second controller 121 to the first controller 111.

Upon receipt of the information on products, the first controller 111 transmits the information on the received products to the server 200. Next, the first controller 111 may receive route information for products delivery from the server 200. To this end, upon receipt of information on products from the first controller 111, the server 200 may create a delivery route using information on a delivery destination of the corresponding product, and transmit the created delivery route to the first controller 111.

Upon receipt of the information on the delivery route of products, the first controller 111 may transmit the delivery route information to the input/output device 113 so that the corresponding information is displayed on the input/output device 113.

Delivery begins (S111).

In response to the delivery route for products delivery being displayed on the input/output device 113 through S109, the user starts products delivery along the displayed delivery route.

The delivery destination and delivery route are guided (S113).

The delivery and the delivery route are displayed on the input/output device 113, and the user moves to the delivery destination according to the delivery route displayed on the input/output device 113. The delivery route displayed on the input/output device 113 may be an optimal delivery route so that delivery may be performed quickly according to delivery destinations of the products received in the cargo part 120. Such an optimal delivery route may be set according to the delivery destinations of the products, or may be set according to the type or quantity of products to be delivered.

The input/output device 113 may be, for example, and may provide information on driving, such as a status of the mobility device 100 and a route guidance, and entertainment elements for occupants of the mobility device 100 together.

The products are released after arrival at the delivery destination (S115).

After arriving at the delivery destination, the user opens the cargo part 120 to release the product. At this time, the user may confirm whether the product corresponds to the delivery destination.

Whether the release of the product has been completed is confirmed (S117).

The user confirms whether the delivery destination of the product is correct at the delivery address. In addition, the user recognizes the product with the product identifier 123 and releases the product from the cargo part 120. At this time, the product identifier 123 transmits information on the recognized product to the first controller 111 through the second controller 121 in order to confirm whether the recognized product is a product to be delivered to the corresponding delivery destination. The first controller 111 confirms whether the delivery destination of the product recognized by the product identifier 123 corresponds to a location where the mobility device 100 stops. Then, the first controller 111 transmits whether the delivery destination is correct to the product identifier 123 through the second controller 121.

The delivery destination is reconfirmed (S119).

An indicator (e.g., a light emitting lamp or a light emitting diode (LED)) may be disposed in the product identifier 123 to indicate whether a location at which the mobility device 100 is positioned is within a predetermined distance range from the delivery destination. In other words, the product identifier 123 may receive information about whether the location where the mobility device 100 is positioned corresponds to the delivery destination of the corresponding product from the first controller 111, and display the corresponding information through the indicator according to the received information.

Accordingly, if the delivery destination of the product recognized by the product identifier 123 is displayed as being different from the location where the mobility device 100 is positioned, the user reconfirms the delivery destination of the product.

The product is delivered (S121).

Upon confirming that the product recognized by the product identifier 123 has been recognized at the correct delivery destination, the user delivers the corresponding product to the delivery address. In S121, the user recognizes the product with the product identifier 123 and confirms whether the delivery destination is correct, and then delivers the product.

The image is photographed (S123).

The user delivers the product to the delivery destination and photographs the delivered product using the user terminal 300 to confirm delivery.

The photographed image is recognized (S125).

In response to the image being photographed in the user terminal 300 and the distance between the user terminal 300 and the terminal communicator 125 being within a predetermined distance range, the user terminal 300 communicates with the terminal communicator 125. As a result, the photographed image is transmitted from the user terminal 300 to the terminal communicator 125. Next, in response to the image having been transmitted from the user terminal 300, the terminal communicator 125 recognizes the transmitted image.

Herein, the second controller 121 matches and recognizes the image transmitted from the user terminal 300 through the terminal communicator 125 with the delivered product. To this end, the user terminal 300 may leave a message for matching the photographed image with the delivered product in the picture, and accordingly, the photographed image and the delivered product may be matched with each other. However, it is not limited thereto, and matching between the images photographed and the delivered products may be made in various ways.

The image photographed at S125 may be recognized based on artificial intelligence (AI). In other words, when the image that may prove delivery completion is received through the terminal communicator 125, the terminal communicator 125 transmits the corresponding image to the second controller 121, and the second controller 121 transmits the corresponding image to the first controller 111 again. Accordingly, the first controller 111 may recognize the AI-based photographed image as an image in which delivery of the product has been completed.

The delivery completion is guided (S127).

When the second controller 121 recognizes the image transmitted through the terminal communicator 125, the second controller 121 transmits the recognized image to the first controller 111. Sequentially, the first controller 111 transmits the transmitted image to the server 200. As such, when the delivery completed image is transmitted to the server 200, the server 200 transmits the image to a customer who received the product, along with a notification of delivery completion.

As is apparent from the above, the base part and the cargo part may be separated, and when the cargo part and the base part are coupled they may be coupled in a plug-and-play manner, thereby replacing conveniently the cargo part.

In addition, in some implementations, the cargo part may be replaced from the base part, so that different types of products may be transported and delivered using one base part.

On the other hand, the above-described implementations may be implemented in the form of a recording medium storing instructions executable by a computer. The instructions may be stored in the form of program code. When the instructions are executed by a processor, a program module is generated by the instructions so that the operations of the disclosed implementations may be carried out. The recording medium may be implemented as a computer-readable recording medium.

The computer-readable recording medium includes all types of recording media storing data readable by a computer system. Examples of the computer-readable recording medium include a Read Only Memory (ROM), a Random Access Memory (RAM), a magnetic tape, a magnetic disk, a flash memory, an optical data storage device, or the like.

What is claimed is:

1. A mobility apparatus comprising:
a base part including a loading part; and
a cargo part detachably coupled to the loading part and defining a space configured to receive one or more objects,
wherein the cargo part includes an product identifier configured to, based on the one or more objects being received or released, recognize the one or more objects.

2. The mobility apparatus of claim 1, wherein the base part further comprises:
an input/output device configured to (i) display a delivery destination at which the one or more objects are to be delivered and a delivery route and (ii) receive information from a user; and
a first controller configured to recognize that the cargo part is coupled to the loading part and control the input/output device.

3. The mobility apparatus of claim 2, wherein the cargo part further comprises a second controller configured to communicate with the first controller to transmit, to the first controller, information regarding the one or more objects.

4. The mobility apparatus of claim 3, wherein the first controller is further configured to:
based the one or more objects being received at the cargo part, receive information recognized by the product identifier through the second controller, and
control the input/output device so that the input/output device displays the delivery destination and the delivery route according to the information recognized by the product identifier.

5. The mobility apparatus of claim 4, wherein the first controller is further configured to:
transmit, to an external server, the information recognized by the product identifier; and
receive, from the external server, information regarding the delivery destination and the delivery route for the one or more objects.

6. The mobility apparatus of claim 3, wherein the cargo part further comprises a terminal communicator configured to communicate with a user terminal associated with the user and receive, from the user terminal, an image related to completion of the delivery.

7. The mobility apparatus of claim 6, wherein the second controller is configured to receive the image from the terminal communicator and compare the image with a delivery completed product.

8. The mobility apparatus of claim 7, wherein the first controller is configured to receive the image from the second controller and transmit the received image to an external server to be transmitted to a customer of the delivery completed product.

9. The mobility apparatus of claim 3, wherein the second controller is configured to, based on the one or more objects being received at the cargo part, store information recognized by the product identifier.

10. The mobility apparatus of claim 9, wherein the second controller is configured to, based on the cargo part being coupled to the loading part, transmit, to the first controller, the stored information regarding the one or more objects.

11. A method of controlling a mobility apparatus, the method comprising:
receiving, at a cargo part, one or more objects for delivery;
coupling the cargo part to a loading part of a base part of the mobility apparatus;
transmitting, based on the cargo part being coupled to the loading part, information regarding the one or more objects to the base part; and
delivering the one or more objects by moving the base part.

12. The method of claim 11, wherein:
the cargo part includes a second controller at which information regarding the one or more objects is stored, and the base part includes a first controller at which information regarding the one or more objects is received from the second controller, and
transmitting the information regarding the one or more objects includes establishing communication connection between the first controller and the second controller to transmit the information.

13. The method of claim 12, wherein:
the base part further comprises an input/output device configured to display a delivery destination at which the one or more objects are to be delivered and a delivery route,
the first controller is configured to control the input/output device, and
delivering the one or more objects includes displaying the delivery destination and the delivery route on the input/output device.

14. The method of claim 13, wherein storing of the one or more objects includes inputting information regarding the one or more objects through a product identifier disposed in the cargo part.

15. The method of claim 14, wherein delivering the one or more objects further comprises:
inputting information that the one or more objects are released through the product identifier; and
confirming, based on the one or more objects being released, whether the one or more objects and the delivery destination are matched.

16. The method of claim 15, wherein confirming whether the one or more objects and the delivery destination are matched comprises confirming, by the first controller, whether the delivery destination of the product recognized by the product identifier and a location of the base part are within a predetermined range.

17. The method of claim 12, further comprising:
recognizing an image related to completion of the delivery of the one or more objects; and
transmitting the image to an outside of the mobility apparatus so that the image is transmitted from the first controller to a customer of the delivered one or more objects.

18. The method of claim 17, further comprising matching, by the second controller, the image and the delivered one or more objects.

19. The method of claim 18, wherein the first controller is configured to transmit the image to an external server so that the image is transmitted to the customer.
